(19) United States
(12) Patent Application Publication
(10) Pub. No.: US 2026/0070601 A1
(43) Pub. Date: Mar. 12, 2026

(54) VARIABLE STEERING WHEEL

(71) Applicants: HYUNDAI MOTOR COMPANY, Seoul (KR); KIA CORPORATION, Seoul (KR)

(72) Inventors: Hong Zhu Tang, Yantai (CN); Guo Shen, Yantai (CN); Chao Cheng, Yantai (CN); Guang You Dong, Yantai (CN)

(73) Assignees: HYUNDAI MOTOR COMPANY, Seoul (KR); KIA CORPORATION, Seoul (KR)

(21) Appl. No.: 19/325,278

(22) Filed: Sep. 10, 2025

(30) Foreign Application Priority Data
Sep. 11, 2024 (CN) 202411273132.1

(51) Int. Cl. B62D 1/08; B60R 21/203

(52) U.S. Cl. CPC B62D 1/08; B60R 21/203

(57) ABSTRACT

A variable steering wheel includes: a steering device mounted on a lower end of a main shaft to steer a vehicle according to rotation of the variable steering wheel; a first handle assembly and a second handle assembly; a handle connection arm that includes a main shaft mounting hole located in a center portion of the handle connection arm, and a pair of linear guide grooves disposed on opposite sides of the main shaft mounting hole; and a pair of linear movement assemblies configured to linearly move along the handle connection arm. In particular, the first handle assembly and the second handle assembly are pivotably connected to the pair of linear movement assemblies by passing through the pair of linear guide grooves, respectively.

### CROSS-REFERENCE TO RELATED APPLICATION

This application claims priority to and the benefit of Chinese Patent Application No. 202411273132.1 filed with the Chinese Intellectual Property Office on Sep. 11, 2024, the entire contents of which are incorporated herein by reference.

### FIELD

The present disclosure relates to a steering wheel for a vehicle, and more particularly, to a variable steering wheel.

### BACKGROUND

Although autonomous driving technology has been developed, the existing steering wheels take up a lot of space and are not helpful for realizing autonomous driving. Therefore, the shape of the steering wheel may need to be changed or folded during autonomous driving. A new variable steering wheel has a simple structure and a small size, and a shape thereof may be changed according to driving habits of various drivers. In addition, a new variable steering wheel may provide more steering wheel modes, and length and angle of a steering wheel handle may be easily changed.

CN216684570U discloses a universal automobile steering wheel suitable for manned and unmanned driving, capable of adjusting the steering wheel according to an operation mode, rotating a handle in a state in which a center base is fixed in a manned driving mode, raising the center base and storing a hidden handle in an unmanned driving mode, thereby significantly saving space in a vehicle and improving driving safety and comfort. This steering wheel has a simple structure, but it cannot be folded and is large in size.

CN114394149A discloses a foldable steering wheel including a main body and fixed members connected to left and right ends of the main body wherein upper and lower ends of the fixed members are each connected to a folding member, and a power mechanism is mounted inside the main body. The power mechanism rotates the folding member through a power member so that the folding member is in close contact with the main body, a body of the fixed member is connected to the main body, an end thereof is vertically connected to the center of a fixed rim, and the both ends of the fixed rim are connected to the folding member to form left and right rims, respectively. This steering wheel has a simple structure, but a deformation range of the steering wheel is limited.

KR102118012B1 discloses a variable steering wheel and an operating method thereof. The variable steering wheel is a variable steering wheel including a hub connected to a steering column of a vehicle and a grip portion connected to the hub by a spoke. The variable steering wheel includes a detecting unit that tracks a position of the user's hand around the variable steering wheel and an actuator that moves the spoke relative to the hub to move the grip portion to the position of the hand tracked by the detecting unit. The variable steering wheel may change an angle of a handle, but cannot change a shape thereof.

The information disclosed in this Background section is only to enhance understanding of the background of the present disclosure and therefore it may contain information that does not form the prior art that is already known to a person of ordinary skill in the art.

### SUMMARY

The present disclosure provides a steering wheel having a simple structure whose shape may be changed according to various driving styles.

The present disclosure also provides a steering wheel whose diameter may be changed according to various driver demands.

The present disclosure provides a steering wheel whose length and angle may be changed according to driving habits.

The present disclosure also provides a steering wheel whose handle may be completely folded to be suitable for autonomous driving.

An embodiment of the disclosure provides a variable steering wheel. The variable steering wheel includes: a steering device mounted on a first end (e.g., a lower end) of a main shaft and configured to steer a vehicle according to rotation of the variable steering wheel; a first handle assembly (e.g., a left handle assembly) and a second handle assembly (e.g., a right handle assembly); and a handle connection arm. The handle connection arm includes: a main shaft mounting hole located in a center portion of the handle connection arm, and a plurality of linear guide grooves respectively disposed on opposite sides of the main shaft mounting hole. The variable steering wheel further includes a pair of linear movement assemblies configured to linearly move along the handle connection arm. In particular, the first handle assembly and the second handle assembly are pivotably connected to the pair of linear movement assemblies through the plurality of linear guide grooves, respectively.

In an embodiment, the plurality of linear guide grooves may include a first pair of linear guide grooves and a second pair of linear guide grooves, which are disposed at end portions of the handle connection arm, respectively. In particular, the pair of linear movement assemblies respectively pass through the first pair of linear guide grooves and the second pair of linear guide grooves.

The first handle assembly may include a first handle body (e.g., a left handle body) and a first handle shaft (e.g., a left handle shaft), and the first handle shaft may be fixedly mounted at a center portion of the first handle body and extend vertically with respect to the first handle body. In another embodiment, the second handle assembly may include a second handle body (e.g., a right handle body) and a second handle shaft (e.g., a right handle shaft), and the second handle shaft may be fixedly mounted at a center portion of the second handle body and extend vertically with respect to the second handle body. Each of the pair of linear movement assemblies may include a linear movement device and a linear movement block, and the linear movement device may be mounted at the linear movement block. Each of the first handle shaft and the second handle shaft may be pivotably connected to a corresponding linear movement block by passing through a corresponding linear guide groove, among the plurality of linear guide grooves, at an end of the handle connection arm.

In another embodiment, the handle connection arm may further include an upper wall and a lower wall, which are configured to form a pair of track cavities. The pair of track cavities are configured to extend from both ends toward the center portion, and linear guide groove of the plurality of linear guide grooves may respectively penetrate the upper lower walls of the handle connection arm. The variable steering wheel may further include a pair of rack gears, each being mounted on a bottom surface of the lower wall within a corresponding track cavity among the pair of track cavities. Each linear movement device may include a movement assembly gear configured to rotate, and each movement assembly gear may be engaged with a corresponding rack gear among the pair of rack gears.

The variable steering wheel may further include: an airbag and function button assembly mounted on a second end (e.g., an upper end) of the main shaft. In particular, the airbag and function button assembly may include a multifunction button including a diameter increase button and a diameter decrease button, and the diameter increase button may be configured to control each movement assembly gear to rotate forward to move the corresponding linear movement assembly radially outward. The diameter decrease button may be configured to control each movement assembly gear to rotate backward to move the corresponding linear movement assembly radially inward.

The variable steering wheel may further include: an angle adjustment mechanism. The angle adjustment mechanism may include: a pair of handle gears, each fixedly mounted at a lower end portion of each of the first handle shaft and the second handle shaft; a pair of handle angle adjustment devices, each including an angle adjustment gear and fixedly mounted within the corresponding linear movement block; and a pair of handle gear covers, each fixedly mounted at a lower end of each of the first handle shaft and the second handle shaft to fix a corresponding handle gear, among the pair of handle gears, in an axial direction. Each angle adjustment gear may be engaged with the corresponding handle gear, and the multifunction button may further include a front angle adjustment button and a rear angle adjustment button. The front angle adjustment button may be configured to rotate each angle adjustment gear of the corresponding handle angle adjustment device forward by a predetermined angle, and the rear angle adjustment button may be configured to rotate each angle adjustment gear of the corresponding handle angle adjustment device backward by a predetermined angle.

The multifunction button may further include a mode switching button configured to switch a mode of the variable steering wheel between a normal driving mode and an autonomous driving mode. In particular, in the normal driving mode, the airbag and function button assembly may be lowered to a lowest position thereof, and in autonomous driving mode, the airbag and function button assembly rises to the highest position thereof, and the first handle body and the second handle body rotate radially inward until being aligned with the handle connection arm, while moving radially inward, so as to be positioned between the airbag and function button assembly and the handle connection arm.

The airbag and function button assembly may further include a convex shaft extending downward from a center portion of a lower surface thereof. The convex shaft may include a convex shaft hole extending vertically from the lower surface of the airbag and function button assembly, and a sliding key extending in an axial direction of the convex shaft may be provided on an inner surface of the convex shaft hole, a sliding key groove formed may be formed at an upper end portion of the main shaft along the axial direction, a pair of position limiting structures may be provided respectively at upper and lower ends within the sliding key groove, and the sliding key may be slidable within the sliding key groove within a limiting range defined by the pair of position limiting structures.

In an embodiment, front and rear end portions of the first handle body may be hollow tube structures, and the first handle body may include a first sliding groove extending along one surface thereof. The first handle assembly may further include a first handle front extension and a first handle rear extension configured to slide within the hollow tube structures of the first handle body, respectively. Each of the first handle front extension and the first handle rear extension may include a first toggle button, and the first toggle button may pass through the first sliding groove and may be exposed from the one surface of the first handle body. Front and rear end portions of the second handle body may be hollow tube structures, and the second handle body may include a second sliding groove extending along one surface thereof. The second handle assembly may further include a second handle front extension and a second handle rear extension configured to slide within the hollow tube structures of the second handle body, respectively. Each of the second handle front extension and the second handle rear extension may include a second toggle button, and the second toggle button passes through the second sliding groove and may be exposed from the one surface of the second handle body.

In an embodiment, the steering device may include: an upper cover including an upper cover shaft hole; a steering gear fixedly mounted at a lower end portion of the main shaft; an end shaft cover assembly fixedly mounted at the first end of the main shaft and including a magnetic body; a printed circuit board (PCB) assembly including an angle sensor; a steering force simulation device including a feedback gear; and a lower cover coupled to the upper cover. In particular, the main shaft may penetrate the upper cover shaft hole, the angle sensor may be disposed to face the magnetic body and configured to detect a rotation angle of the main shaft, the feedback gear may be configured to engage with the steering gear to receive a steering torque signal and execute steering feedback, and the PCB assembly and the steering force simulation device may be mounted on the lower cover.

The airbag and function button assembly may further include a steering angle display unit indicating a steering angle of a vehicle.

In another embodiment, the variable steering wheel may include two rack gears provided in each track cavity, and the two rack gears may be symmetrically positioned on opposite sides of a corresponding linear guide groove among the linear guide grooves. Two movement assembly gears may be provided on each linear movement block, and each movement assembly gear may be engaged with a corresponding rack gear among the two rack gears.

The airbag and function button assembly may further include a safety airbag and a mode indicator light, and the mode indicator light may be disposed to surround the safety airbag and may be configured to emit light of different colors according to a change in a mode of the variable steering wheel, a change in a diameter of the steering wheel, or a change in an angle of the first handle assembly or the second handle assembly.

Another embodiment of the disclosure provides a method of assembling a variable steering wheel. The method of assembling the variable steering wheel includes: fixedly mounting rack gears on bottoms of a pair of track cavities at both end portions of a handle connection arm, respectively; mounting a pair of linear movement assemblies in a corresponding track cavity, among the pair of cavities, at both ends of the handle connection arm so that each movement assembly gear is engaged with the corresponding rack gear; pivotably connecting a first handle shaft (e.g., a left handle shaft) and a second handle shaft (e.g., a right handle shaft) to a pair of linear movement blocks by passing through a pair of linear guide grooves at both ends of the handle connection arm, respectively; fixedly mounting a handle gear to a lower end portion of each of the first handle shaft and the second handle shaft; mounting a handle angle adjustment device so as to be engaged with the handle gear; fixedly mounting a handle gear cover to a lower end of each of the first handle shaft and the second handle shaft; allowing a main shaft to pass through a main shaft mounting hole of the handle connection arm and an upper cover and fixedly mounting a steering gear to a lower end of the main shaft; fixedly mounting an end shaft cover assembly to the lower end of the main shaft; mounting a PCB assembly and a steering force simulation device at a lower cover; connecting the upper cover and the lower cover using a connection member; and mounting an airbag and function button assembly at an upper end of the main shaft.

Another embodiment of the disclosure provides a method of adjusting a variable steering wheel. The method includes: using the variable steering wheel accorindg to an embodiment of the disclosure. The adjusting method further includes: entering an autonomous driving mode by pressing the mode switching button of the multifunction button in a normal driving mode; or entering the normal driving mode by pressing the mode switching button of the multifunction button in the autonomous driving mode. In particular, in the autonomous driving mode, the airbag and function button assembly rises to the highest position thereof, and the first handle body and the second handle body rotate radially inward until being aligned with the handle connection arm, while moving radially inward, so as to be positioned between the airbag and function button assembly and the handle connection arm. In the normal driving mode, the first handle body and the second handle body move to the outermost position in a radial direction and rotate to face each other, and the airbag and function button assembly may be lowered to the lowest position thereof.

The adjusting method may further include: moving the first handle body and the second handle body radially outward by pressing the diameter increase button in the normal driving mode; and moving the first handle body and the second handle body radially inward by pressing the diameter decrease button in the normal driving mode.

The adjusting method may further include: rotating the first handle body and the second handle body to face forward at a certain angle by pressing a front angle adjustment button in the normal driving mode; or rotating the first handle body and the second handle body to face backward at a certain angle by pressing a rear angle adjustment button in the normal driving mode.

The adjusting method may further include: stretching or retracting the first handle front extension or the first handle rear extension relative to the first handle body by pushing the first toggle button forward or backward in the normal driving mode; or stretching or retracting the second handle front extension and the second handle rear extension relative to the second handle body by pushing the second toggle button forward or backward in the normal driving mode.

The variable steering wheel and the method for adjusting the same according to the disclosure have the following beneficial effects.

A new structural form for changing the shape of the steering wheel (e.g., linear movement and rotation type) may be provided, and the diameter of the steering wheel, and the length and the angle of the steering wheel handle may be changed, so as to be suitable for various modes and convenience.

In addition, the rotation angle and the steering mode lighting may be visualized.

The steering wheel may be completely folded in a compact mode, which significantly saves space in an autonomous driving mode and makes the vehicle interior space simple and comfortable.

It should be understood that the term “vehicle” or “vehicular” or other similar terms used herein generally include motor vehicles, such as passenger cars, including sport utility vehicles (SUVs), buses, trucks, and various commercial vehicles; ships, including various boats and vessels, aircraft, and the like; and hybrid vehicles, electric vehicles, plug-in hybrid electric vehicles, hydrogen-powered vehicles, and other alternative fuel (e.g., fuel derived from sources other than petroleum) vehicles.

The methods and devices of the disclosure have other features and advantages, which are apparent from or will be described in detail in the accompanying drawings and the following exemplary embodiments, all of which are intended to illustrate certain principles of the disclosure.

### BRIEF DESCRIPTION OF THE DRAWINGS

FIG. 1 is a schematic diagram illustrating a variable steering wheel according to an embodiment of the present disclosure.

FIG. 2 is an exploded perspective view illustrating a variable steering wheel according to an embodiment of the present disclosure.

FIG. 3 is a schematic diagram illustrating an airbag and function button assembly of a variable steering wheel according to an embodiment of the present disclosure.

FIG. 4A is a schematic diagram illustrating a multifunction button.

FIG. 4B is an enlarged diagram illustrating a steering angle display unit.

FIG. 4C is an exploded perspective view illustrating an assembly of a main shaft, an airbag and function button assembly, and an end shaft cover assembly.

FIG. 5 is a schematic diagram illustrating a handle connection arm of a variable steering wheel according to an embodiment of the present disclosure.

FIG. 6 illustrates a linear movement assembly and an angle adjustment mechanism of a variable steering wheel according to an embodiment of the present disclosure.

FIG. 7 is a schematic diagram illustrating a variable steering wheel according to an embodiment of the present disclosure.

FIG. 8A is a cross-sectional view taken along the line A-A of FIG. 7.

FIG. 8B is a cross-sectional view taken along the line B-B of FIG. 7.

FIG. 9 illustrates a steering device of a variable steering wheel according to an embodiment of the present disclosure.

FIG. 10 is a schematic diagram illustrating a variable steering wheel in a normal driving mode according to an embodiment of the present disclosure.

FIG. 11 is a plan view illustrating a variable steering wheel in a compact mode according to an embodiment of the present disclosure.

FIG. 12 is a front view illustrating a variable steering wheel in a compact mode according to an embodiment of the present disclosure.

FIG. 13 is a plan view illustrating a variable steering wheel in a minimum diameter mode according to an embodiment of the present disclosure.

FIG. 14 is a plan view illustrating a variable steering wheel in a forward adjustment mode according to an embodiment of the present disclosure.

FIG. 15 is a plan view illustrating a variable steering wheel in a backward adjustment mode according to an embodiment of the present disclosure.

FIGS. 16A, 16B, 16C, 16D, 16E, 16F, 16G, and 16H exemplarily illustrate different extension states of a left handle assembly and a right handle assembly of a variable steering wheel according to embodiments of the present disclosure.

It should be understood that the drawings are simplified to illustrate each feature in order to describe the basic principles of the disclosure and are not necessarily drawn to scale. Specific design features (including, for example, specific sizes, directions, positions, and shapes) disclosed in the disclosure are partly determined according to specific application purposes and usage environments.

In these drawings, the same reference numerals throughout the drawings denote the same or equivalent parts of the disclosure.

### DETAILED DESCRIPTION

Hereinafter, certain embodiments of the disclosure are described in detail with reference to the accompanying drawings, so that those of having ordinary skill in the art may easily practice the present disclosure. As those of having ordinary skill in the art would realize, the described embodiments may be modified in various different ways, all without departing from the spirit or scope of the disclosure.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

In describing the components of the form according to the present disclosure, terms such as ‘first,’ ‘second,’ ‘A,’ ‘B,’ ‘(a),’ ‘(b),’ and the like may be used merely to distinguish one component from another. These terms do not imply any particular order, hierarchy, or limitation on the nature or function of the components. Unless otherwise defined, all terms used herein, including technical or scientific terms, have the same meanings as commonly understood by those having ordinary skill in the art to which the present disclosure pertains.

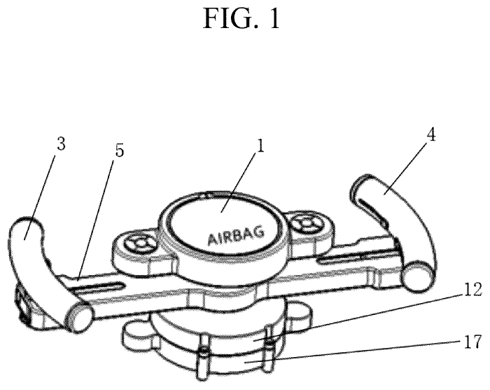

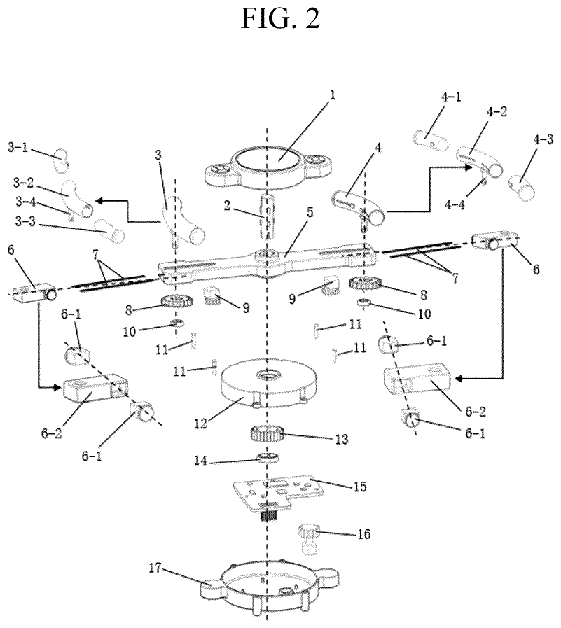

FIG. 1 is a schematic diagram of a variable steering wheel according to an embodiment of the present disclosure, and FIG. 2 is an exploded perspective view of the variable steering wheel according to an embodiment of the present disclosure.

As shown in FIGS. 1 and 2, the variable steering wheel according to an embodiment of the present disclosure includes an airbag and function button assembly 1, a main shaft 2, a left handle assembly 3, a right handle assembly 4, a handle connection arm 5, a linear movement assembly 6, and a rack gear 7.

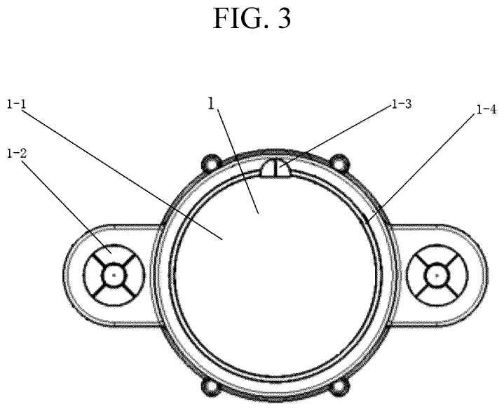

FIG. 3 is a schematic diagram illustrating the airbag and function button assembly 1 of the variable steering wheel according to an embodiment of the present disclosure.

As shown in FIG. 3, the airbag and function button assembly 1 includes a safety airbag 1-1 located in a center portion and multifunction buttons 1-2 located on both left and right sides. The multifunction button 1-2 on one side (e.g., the left side) is for controlling the left handle assembly 3 and the right handle assembly 4. The multifunction button 1-2 on the other side may be used for other specifically defined functions.

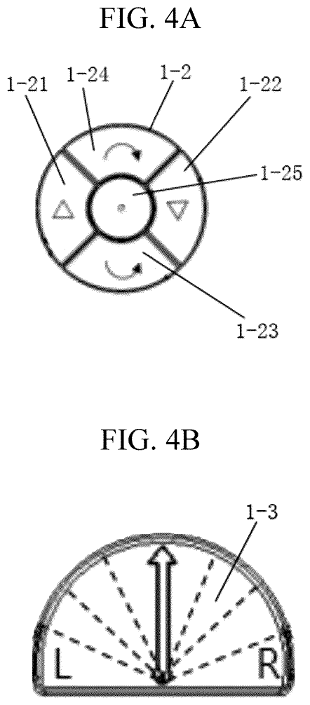

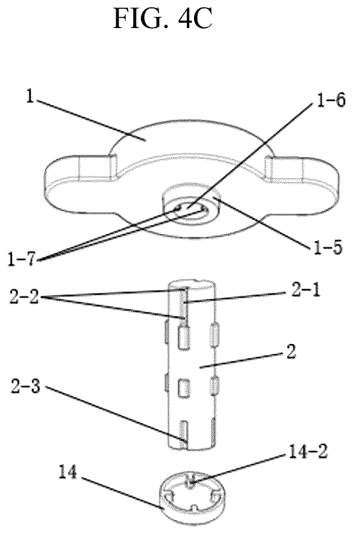

FIG. 4A is an enlarged view illustrating the multifunction button of the airbag and function button assembly of the variable steering wheel according to an embodiment of the present disclosure.

As shown in FIG. 4A, the multifunction button 1-2 is a set of buttons and includes a diameter increase button 1-21, a diameter decrease button 1-22, a front angle adjustment button 1-23, a rear angle adjustment button 1-24, and a mode switching button 1-25. The diameter increase button 1-21 is configured to increase a turning radius of the left handle assembly 3 and the right handle assembly 4 with respect to the main shaft 2, and the diameter decrease button 1-22 is configured to decrease the turning radius of the left handle assembly 3 and the right handle assembly 4 with respect to the main shaft 2. The front angle adjustment button 1-23 is configured to adjust the left handle assembly 3 and the right handle assembly 4 to rotate forward at a certain angle, and the rear angle adjustment button 1-24 is configured to adjust the left handle assembly 3 and the right handle assembly 4 to rotate backward at a certain angle.

Regardless of the adjustment of the multifunction button 1-2, the left handle assembly 3 and the right handle assembly 4 are always symmetrical with respect to the center of the variable steering wheel.

The mode switching button 1-25 is configured to switch the left handle assembly 3 and the right handle assembly 4 between a normal driving mode and an autonomous driving mode. In the normal driving mode, positions of the left and right handle assemblies 3 and 4 of the steering wheel are the same as positions of left and right handle assemblies of a conventional steering wheel, and in the autonomous driving mode, the left handle assembly 3 and the right handle assembly 4 of the steering wheel are folded to align with the handle connection arm 5, therby implementing a compact mode.

The airbag and function button assembly 1 may further include a steering angle display unit 1-3 provided on a front upper side of the safety airbag 1-1 to indicate the steering angle of the steering wheel. FIG. 4B is an enlarged view illustrating the steering angle display unit of the airbag and function button assembly of the variable steering wheel according to an exemplary embodiment of the disclosure.

The airbag and function button assembly 1 may further include a mode indicator light 1-4. The mode indicator light 1-4 may be provided to surround the safety airbag 1-1 and is used to change color according to a change in the mode of the variable steering wheel, a change in the diameter of the variable steering wheel, or a change in the angle of the left handle assembly 3 or the right handle assembly 4.

FIG. 4C is an exploded perspective view illustrating an assembly of the main shaft 2, the airbag and function button assembly 1, and an end shaft cover assembly 14.

As shown in FIG. 4C, the airbag and function button assembly 1 further includes a convex shaft 1-5 extending downward from the center portion of a lower surface, a convex shaft hole 1-6 extending in an axial direction from the lower surface of the airbag and function button assembly 1 is formed on the convex shaft 1-5, and a sliding key 1-7 extending in the axial direction is formed on an inner surface of the convex shaft 1-5. In an embodiment, the number of sliding keys 1-7 is two.

The airbag and function button assembly 1 is mounted at an upper end of the main shaft 2. A sliding key groove 2-1 is formed at an upper end portion of the main shaft 2 along the axial direction, and position limiting structures 2-2 (e.g., position limiting blocks) are provided at both upper and lower ends of the sliding key groove 2-1. The number and positions of the sliding key grooves 2-1 correspond to the number and positions of the sliding keys 1-7, and each sliding key 1-7 may slide within the corresponding sliding key groove 2-1 within a range limited by the position limiting structures 2-2. Therefore, the airbag and function button assembly 1 may move up and down along the main shaft 2.

Catch grooves 2-3 formed in the axial direction are provided at a lower end portion of the main shaft 2. Catch connection blocks 14-2 are provided at the end shaft cover assembly 14. By inserting each of the catch connection block 14-2 into the corresponding catch groove 2-3, the end shaft cover assembly 14 may be fixedly mounted at the lower end of the main shaft 2.

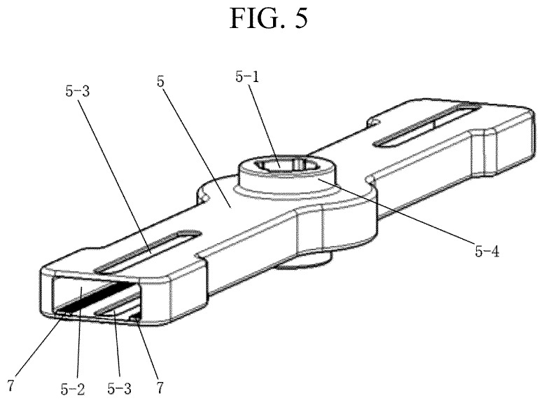

FIG. 5 is a schematic diagram illustrating a handle connection arm of the variable steering wheel according to an embodiment of the disclosure.

As shown in FIG. 5, a main shaft mounting hole 5-1 and a main shaft boss 5-4 protruding upward are provided at a center portion of the handle connection arm 5. The main shaft mounting hole 5-1 penetrates the handle connection arm 5 and the main shaft boss 5-4 vertically. The main shaft 2 is fixedly mounted in the main shaft mounting hole 5-1.

On both sides of the main shaft mounting hole 5-1, a track cavity 5-2 extending in a straight line along the handle connection arm 5 is formed inside the handle connection arm 5. The rack gear 7 is provided at the bottom of the track cavity 5-2. Linear guide grooves 5-3 penetrating the handle connection arm 5 vertically are formed on upper and lower walls of the track cavity 5-2, and the linear guide grooves 5-3 extend along the track cavity 5-2. As illustrated in FIG. 5, the guide grooves 5-3 include a first pair of linear guide grooves and a second pair of linear guide grooves, which are disposed at end portions of the handle connection arm, respectively. The pair of linear movement assemblies respectively pass through the first pair of linear guide grooves and the second pair of linear guide grooves. In an embodiment, two rack gears 7 are provided on a bottom surface of the lower wall within each track cavity 5-2, and the two rack gears 7 are symmetrically positioned on opposite sides of the linear guide groove 5-3 of the lower wall.

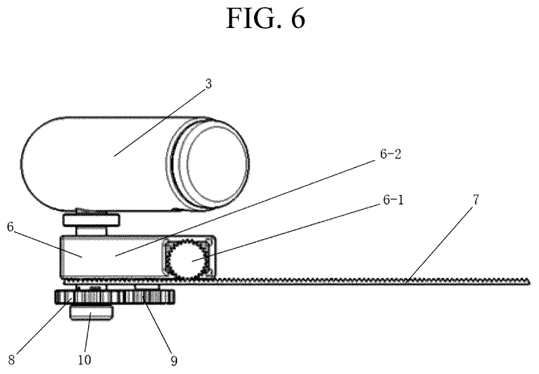

FIG. 6 illustrates a linear movement assembly and an angle adjustment mechanism of the variable steering wheel according to an embodiment of the disclosure.

As shown in FIG. 6, the linear movement assembly 6 includes a linear movement device 6-1 and a linear movement block 6-2. The linear movement device 6-1 is provided with a rotatable movement assembly gear. The linear movement device 6-1 is provided in the linear movement block 6-2. The movement assembly gear is provided in the track cavity 5-2 and engaged with the rack gear 7 to enable the linear movement assembly 6 to move along the handle connection arm 5. When two rack gears 7 are provided, two movement assembly gears are provided to correspond to the two rack gears 7, and each movement assembly gear is engaged with the corresponding rack gear 7. The diameter increase button 1-21 controls the movement assembly gear to rotate in a forward direction, thereby moving the linear movement assembly 6 radially outward, and the diameter decrease button 1-22 controls the movement assembly gear to rotate in a reverse direction, thereby moving the linear movement assembly 6 radially inward.

As shown in FIG. 2, the left handle assembly 3 includes a left handle body 3-2 and a left handle shaft 3-4. The left handle body 3-2 has an arc shape, and one end of the left handle shaft 3-4 is fixedly mounted at a center portion of the left handle body 3-2 and extends perpendicularly to a plane on which the left handle body 3-2 is located. The left handle shaft 3-4 passes through the linear guide groove 5-3 on the left side of the handle connection arm 5 and is pivotably connected to the linear movement block 6-2 on the left side. Therefore, the left handle assembly 3 may move along the handle connection arm 5.

The right handle assembly 4 includes a right handle body 4-2 and a right handle shaft 4-4. The right handle body 4-2 has an arc shape, and one end of the right handle shaft 4-4 is fixedly mounted at a center portion of the right handle body 4-2 and extends perpendicularly to a plane on which the right handle body 4-2 is located. The right handle shaft 4-4 passes through the linear guide groove 5-3 on the right side of the handle connection arm 5 and is pivotably connected to the linear movement block 6-2 on the right side. Therefore, the right handle assembly 4 may move along the handle connection arm 5.

The left handle assembly 3 further includes a left handle front extension 3-1 and a left handle rear extension 3-3 provided at both end portions of the left handle assembly 3, and the left handle front extension 3-1 and the left handle rear extension 3-3 may each be stretched or retracted relative to the left handle body 3-2.

For example, the both end portions of the left handle body 3-2 may be hollow tube structures that may accommodate the left handle front extension 3-1 and the left handle rear extension 3-3. The left handle body 3-2 is provided with left sliding grooves 3-5 extending along one surface thereof, and left toggle buttons 3-6 are respectively provided at the corresponding one surface of the left handle front extension 3-1 and the corresponding one surface of the left handle rear extension 3-3. The left toggle buttons 3-6 each passes through the corresponding left sliding groove 3-5 and protrudes from the one surface of the left handle body 3-2. By pushing the left toggle buttons 3-6, the left handle front extension 3-1 or the left handle rear extension 3-3 may be slid stretchably and retractively relative to the left handle body 3-2.

Similarly, the right handle assembly 4 further includes a right handle front extension 4-1 and a right handle rear extension 4-3 provided at both end portions of the right handle assembly 4, and the right handle front extension 4-1 and the right handle rear extension 4-3 may each be stretched or retracted relative to the right handle body 4-2.

For example, both end portions of the right handle body 4-2 may be hollow tube structures that may accommodate the right handle front extension 4-1 and the right handle rear extension 4-3. The right handle body 4-2 is provided with right sliding grooves 4-5 extending along one surface thereof, and right toggle buttons 4-6 are respectively provided at the corresponding one surface of the right handle front extension 4-1 and the corresponding one surface of the right handle rear extension 4-3. The right toggle buttons 4-6 each passes through the corresponding right sliding groove 4-5 and protrudes from the one surface of the right handle body 4-2. By pushing the right toggle buttons 4-6, the right handle front extension 4-1 or the right handle rear extension 4-3 may be slid stretchably and retractively relative to the right handle body 4-2.

The variable steering wheel according to an embodiment of the disclosure may further include an angle adjustment mechanism.

As shown in FIG. 6, the angle adjustment mechanism according to an embodiment of the disclosure includes a handle gear 8, a handle angle adjustment device 9, and a handle gear cover 10. The two handle gears 8 are fixedly mounted to lower end portions of the left handle shaft 3-4 and the right handle shaft 4-4, respectively, and may rotate according to the rotation of the left handle shaft 3-4 and the right handle shaft 4-4. The handle angle adjustment device 9 is fixedly mounted at the linear movement block 6-2. The handle angle adjustment device 9 includes an angle adjustment gear, and the angle adjustment gear is engaged with the handle gear 8. The handle gear cover 10 is fixedly mounted at each of the lower end portions of the left handle shaft 3-4 and the right handle shaft 4-4, thereby fixing the handle gear 8 in the axial direction.

The variable steering wheel according to an embodiment of the disclosure further includes a steering device mounted below the main shaft 2 and implementing steering according to the rotation of the variable steering wheel.

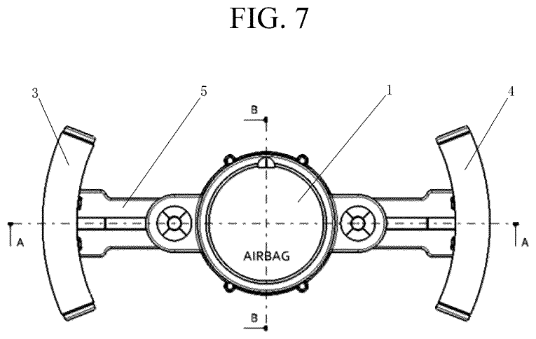

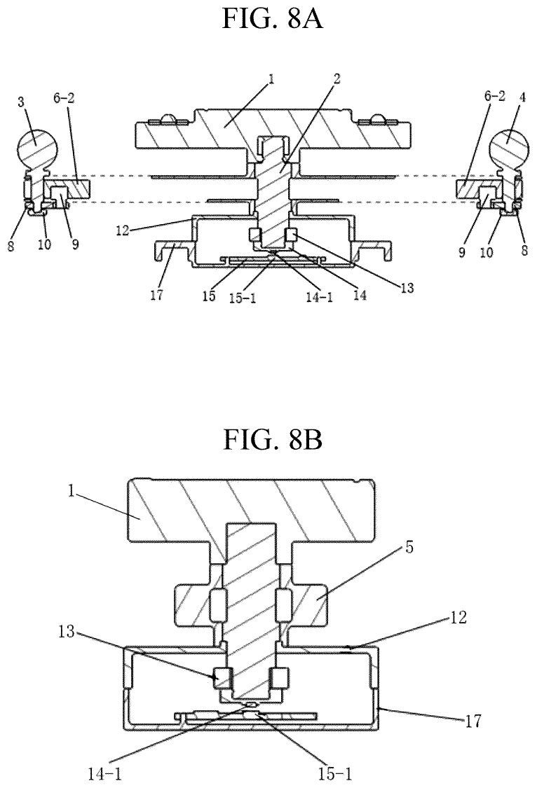

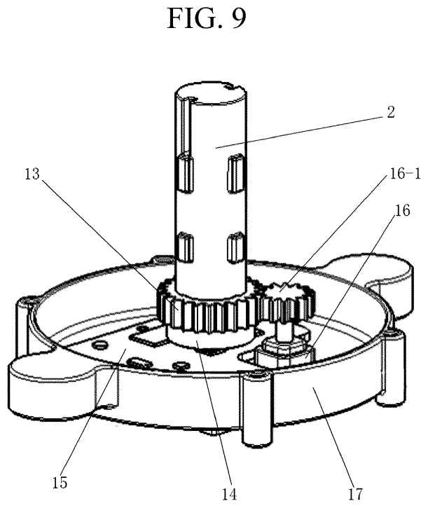

FIG. 7 is a schematic diagram illustrating the variable steering wheel according to an embodiment of the disclosure, FIG. 8A is a cross-sectional view taken along the line A-A of FIG. 7, FIG. 8B is a cross-sectional view taken along the line B-B of FIG. 7, and FIG. 9 illustrates a steering device of the variable steering wheel according to an embodiment of the disclosure.

As illustrated in FIGS. 2, 7, 8A, 8B, and 9, the steering device includes a connection member 11, an upper cover 12, a steering gear 13 fixedly mounted at the lower end portion of the main shaft 2, the end shaft cover assembly 14 fixedly mounted at the lower end of the main shaft 2 and covering the steering gear 13, a PCB assembly 15 for detecting a steering angle of the main shaft 2, a steering force simulation device 16, and a lower cover 17. The PCB assembly 15 and the steering force simulation device 16 may be mounted on the lower cover 17. The end shaft cover assembly 14 includes a magnetic body 14-1, the PCB assembly 15 includes an angle sensor 15-1, and a rotation angle of the main shaft 2 is detected through the magnetic body 14-1 and the angle sensor 15-1. The steering force simulation device 16 includes a feedback gear 16-1, and the feedback gear 16-1 is engaged with the steering gear 13. The upper cover 12 and the lower cover 17 are connected to each other through the connection member 11. For example, the connection member 11 may be a plurality of screws.

When the variable steering wheel is rotated to turn the vehicle, the left handle assembly 3 and the right handle assembly 4 rotate the main shaft 2. Accordingly, the lower steering gear 13 rotates to rotate the feedback gear 16-1. In addition, the steering force simulation device 16 receives a steering torque feedback signal and provides a steering load through the feedback gear 16-1 to simulate steering force. Accordingly, the steering feel is improved.

Hereinafter, a mode switching method of the variable steering wheel according to an embodiment of the disclosure will be described.

Each time the mode switching button 1-25 is pressed, the mode of the variable steering wheel switches between the normal driving mode and the autonomous driving mode.

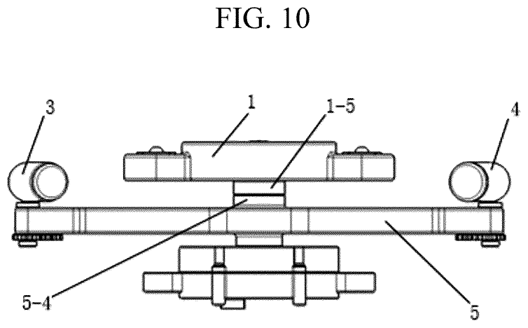

In the normal driving mode, the airbag and function button assembly 1 is lowered to the lowest position thereof. At this time, the sliding key 1-7 of the airbag and function button assembly 1 contacts the position limiting structure 2-2 at the lower end of the sliding key groove 2-1 of the main shaft 2 (as shown in FIGS. 7 and 10).

When the mode switching button 1-25 of the multifunction button 1-2 is pressed in the normal driving mode, the vehicle enters the autonomous driving mode. In this case, the airbag and function button assembly 1 rises to the highest position thereof, and the left handle body 3-2 and the right handle body 4-2 are rotated until they are aligned with the handle connection arm 5 while moving radially inward, so as to be located between the airbag and function button assembly 1 and the handle connection arm 5.

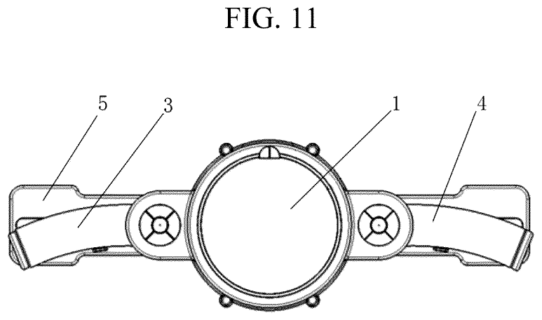

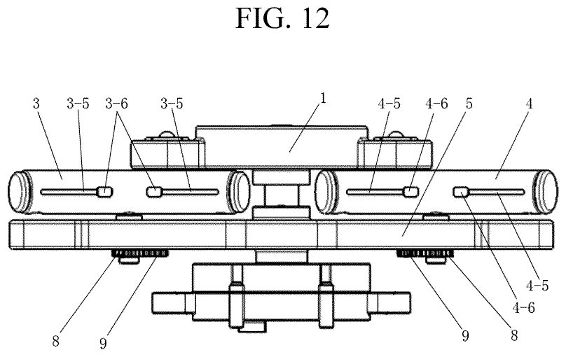

That is, in the autonomous driving mode, the airbag and function button assembly 1 rises to the highest position thereof, and the left handle assembly 3 and the right handle assembly 4 move radially inward and rotate until they are aligned with the handle connection arm 5 so as to be inserted between the airbag and function button assembly 1 and the handle connection arm 5. Accordingly, the left handle assembly 3 and the right handle assembly 4 are folded to implement the compact mode (see FIGS. 11 and 12). At this time, the sliding key 1-7 of the airbag and function button assembly 1 comes into contact with the position limiting structure 2-2 at the upper end of the sliding key groove 2-1 of the main shaft 2.

In the autonomous driving mode, when the mode switching button 1-25 of the multifunction button 1-2 is pressed, the vehicle enters the normal driving mode. In this case, the left handle body 3-2 and the right handle body 4-2 move to the outermost positions in the radial direction and rotate to face each other. In addition, the airbag and function button assembly 1 is lowered to the lowest position thereof.

In the normal driving mode, when the diameter increase button 1-21 is pressed, the linear movement device 6-1 of the linear movement assembly 6 is driven and the movement assembly gear engaged with the rack gear 7 rotates in a first direction. Accordingly, the linear movement assembly 6 moves radially outward, so that the left handle assembly 3 and the right handle assembly 4 move radially outward, thereby increasing the diameter of the variable steering wheel. FIG. 7 illustrates a state in which the diameter of the variable steering wheel is the largest.

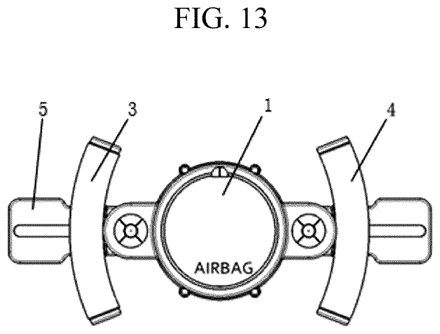

In the normal driving mode, when the diameter reduction button 1-22 is pressed, the linear movement device 6-1 of the linear movement assembly 6 is driven and the movement assembly gear engaged with the rack gear 7 rotates in a second direction. Accordingly, the linear movement assembly 6 moves radially inward, thereby causing the left handle assembly 3 and the right handle assembly 4 to move radially inward, and accordingly, the diameter of the steering wheel decreases. The first and second directions are opposite rotation directions. FIG. 13 illustrates a state in which the diameter of the variable steering wheel is the smallest.

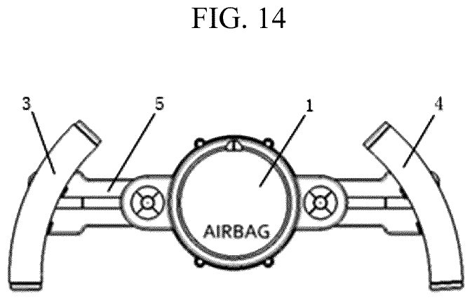

In the normal driving mode, when the front angle adjustment button 1-23 is pressed, the handle angle adjustment device 9 engaged with the handle gear 8 is driven to rotate in a third direction. Accordingly, the left handle assembly 3 and the right handle assembly 4 rotate forward, so that the left handle assembly 3 and the right handle assembly 4 are adjusted to face forward to a certain angle. FIG. 14 illustrates a state in which the variable steering wheel is adjusted to face forward to a certain angle (forward adjustment mode).

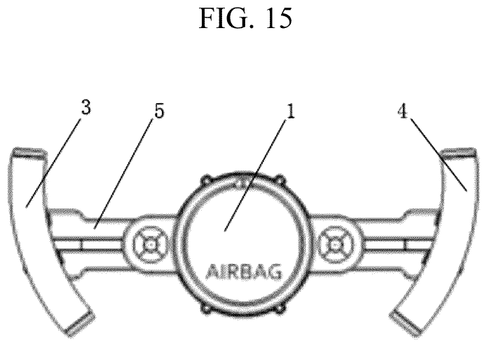

In the normal driving mode, when the rear angle adjustment button 1-24 is pressed, the handle angle adjustment device 9 engaged with the handle gear 8 is driven to rotate in a fourth direction. Accordingly, the left handle assembly 3 and the right handle assembly 4 rotate backward, so that the left handle assembly 3 and the right handle assembly 4 are adjusted to face backward to a certain angle. The third and fourth directions are opposite rotation directions. FIG. 15 illustrates a state in which the variable steering wheel is adjusted to face backward to a certain angle (backward adjustment mode).

In the normal driving mode, when the left toggle button 3-6 is pressed and slid along the left sliding groove 3-5 forward and backward, the left handle front extension 3-1 and the left handle rear extension 3-3 are slid stretchably or retractively relative to the left handle body 3-2 and the length of the handle of the left handle assembly 3 may be changed.

In the normal driving mode, when the right toggle button 4-6 is pressed and slid along the right sliding groove 4-5 forward and backward, the right handle front extension 4-1 and the right handle rear extension 4-3 may be slid stretchably or retractively relative to the right handle body 4-2 and the length of the handle of the right handle assembly 4 may be changed.

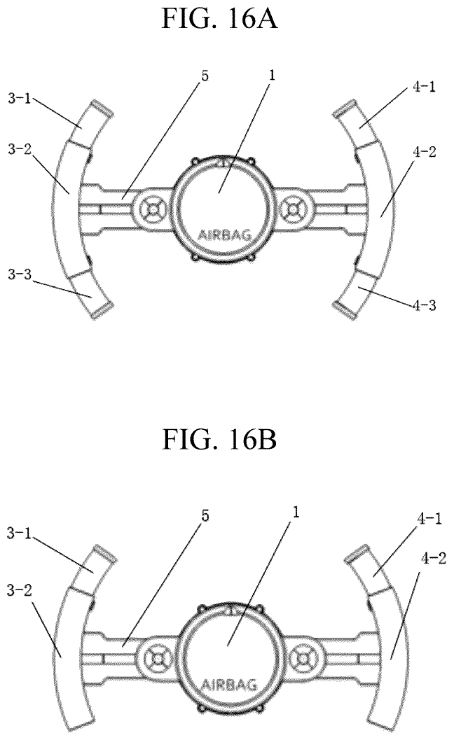

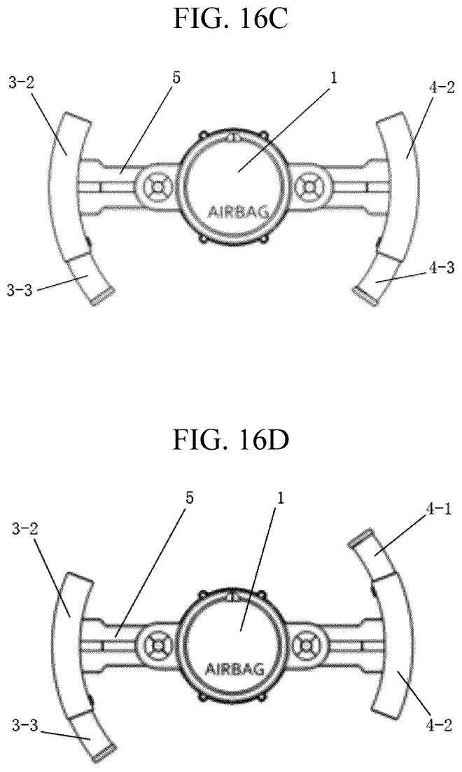

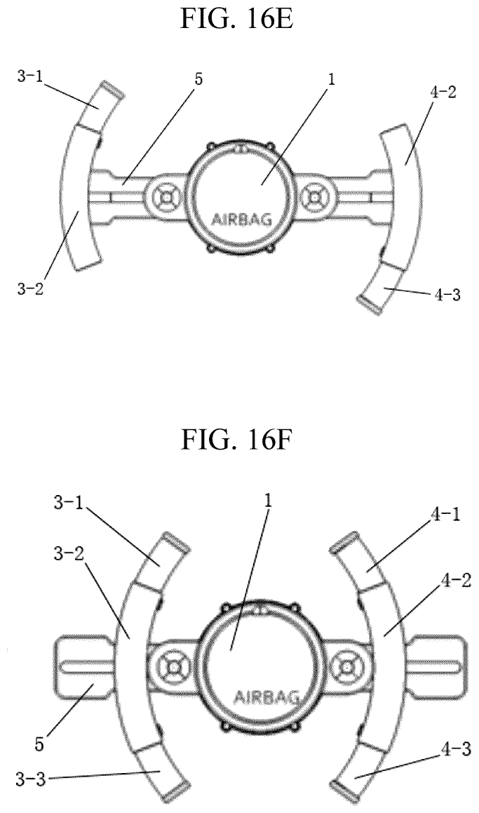

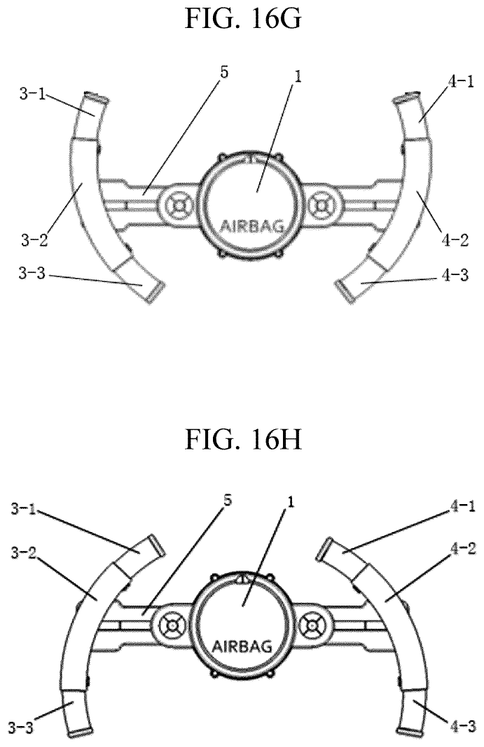

FIGS. 16A, 16B, 16C, 16D, 16E, 16F, 16G, and 16H exemplarily illustrate different extension states of the left handle assembly 3 and the right handle assembly 4 of the variable steering wheel according to an embodiment of the disclosure. Through the stretching of the left handle front extension 3-1, the left handle rear extension 3-3, the right handle front extension 4-1, and the right handle rear extension 4-3 and the positions of the left handle body 3-2 and the right handle body 4-2, the variable steering wheel may implement various states to adapt to various drivers.

Hereinafter, a method for assembling a variable steering wheel according to an embodiment of the disclosure is described. The method for assembling the variable steering wheel includes: fixedly mounting the rack gear 7 in the bottom of the track cavity 5-2 at both ends of the handle connection arm 5; mounting the linear movement assembly 6 in the track cavity 5-2 at both ends of the handle connection arm 5 so that the movement assembly gear is engaged with the rack gear 7; pivotably connecting the left handle shaft 3-4 and the right handle shaft 4-4 to the linear movement block 6-2 by passing through the linear guide grooves 5-3 at both ends of the handle connection arm 5, respectively; and fixedly mounting two handle gears 8 to the lower end portions of the left handle shaft 3-4 and the right handle shaft 4-4, respectively. The method further includes: mounting the handle angle adjustment device 9 so as to be engaged with the handle gears 8; fixedly mounting two handle gear covers 10 to the lower ends of the left handle shaft 3-4 and the right handle shaft 4-4, respectively; allowing the main shaft 2 to pass through the main shaft mounting hole 5-1 of the handle connection arm 5 and the upper cover 12 and fixedly mounting the steering gear 13 to the lower end portion of the main shaft 2; fixedly mounting the end shaft cover assembly 14 to the lower end of the main shaft 2; mounting the PCB assembly 15 and the steering force simulation device 16 at the lower cover 17; connecting the upper cover 12 and the lower cover 17 using the connection member 11; and mounting the airbag and function button assembly 1 at the upper end of the main shaft 2.

In order to better construe and precisely define the appended claims, the terms “upper”, “lower”, “inner”, and “outer” are used to describe the features of the exemplary implementations with reference to the locations of these features shown in the drawings.

The description of specific embodiments of the present disclosure is for the purpose of explanation and description. The description is not intended to be exhaustive or to limit the disclosure to the disclosed precise form, and it is clear that all slight modifications and changes may be made in accordance with the teachings. The embodiments are selected and described in order to interpret the specific principles of the disclosure and its practical applications, so that thos having ordinary skill in the art may utilize and implement various exemplary embodiments and various alternative methods and modifications of the disclosure. The scope of the disclosure is limited by the appended claims and their equivalent forms.

What is claimed is:

1. A variable steering wheel comprising:
a steering device mounted on a first end of a main shaft and configured to steer a vehicle according to rotation of the variable steering wheel;
a first handle assembly and a second handle assembly;
a handle connection arm including:
a main shaft mounting hole located in a center portion, and
a plurality of linear guide grooves respectively disposed on opposite sides of the main shaft mounting hole; and
a pair of linear movement assemblies configured to linearly move along the handle connection arm,
wherein the first handle assembly and the second handle assembly are pivotably connected to the pair of linear movement assemblies through the plurality of linear guide grooves.

2. The variable steering wheel of claim 1, wherein the plurality of linear guide grooves includes a first pair of linear guide grooves and a second pair of linear guide grooves, which are disposed at end portions of the handle connection arm, respectively, and
wherein the pair of linear movement assemblies respectively pass through the first pair of linear guide grooves and the second pair of linear guide grooves.

3. The variable steering wheel of claim 1, wherein:
the first handle assembly includes a first handle body and a first handle shaft, and the first handle shaft is fixedly mounted at a center portion of the first handle body and extends vertically with respect to the first handle body;
the second handle assembly includes a second handle body and a second handle shaft, and the second handle shaft is fixedly mounted at a center portion of the second handle body and extends vertically with respect to the second handle body;
each of the pair of linear movement assemblies includes a linear movement device and a linear movement block, and the linear movement device is mounted at the linear movement block; and
each of the first handle shaft and the second handle shaft is pivotably connected to a corresponding linear movement block by passing through a corresponding linear guide groove, among the plurality of linear guide grooves, at an end of the handle connection arm.

4. The variable steering wheel of claim 3, wherein:
the handle connection arm further includes an upper wall and a lower wall, which are configured to form a pair of track cavities; and
the pair of track cavities are configured to extend from both ends toward the center portion, and linear guide grooves of the plurality of linear guide grooves are configured to respectively penetrate the upper wall and the lower wall of the handle connection arm.

5. The variable steering wheel of claim 4, further comprising:
a pair of rack gears, each being mounted on a bottom surface of the lower wall within a corresponding track cavity among the pair of track cavities,
wherein each linear movement device includes a movement assembly gear configured to rotate, and each movement assembly gear is engaged with a corresponding rack gear among the pair of rack gears.

6. The variable steering wheel of claim 5, further comprising:
an airbag and function button assembly mounted on a second end of the main shaft,
wherein the airbag and function button assembly includes a multifunction button including a diameter increase button and a diameter decrease button, and
wherein the diameter increase button is configured to control each movement assembly gear to rotate forward to move a corresponding linear movement assembly radially outward, and the diameter decrease button is configured to control each movement assembly gear to rotate backward to move the corresponding linear movement assembly radially inward.

7. The variable steering wheel of claim 6, further comprising:
an angle adjustment mechanism,
wherein the angle adjustment mechanism includes:
a pair of handle gears, each fixedly mounted at a lower end portion of each of the first handle shaft and the second handle shaft;
a pair of handle angle adjustment devices, each including an angle adjustment gear and fixedly mounted within the corresponding linear movement block; and
a pair of handle gear covers, each fixedly mounted at a lower end of each of the first handle shaft and the second handle shaft to fix a corresponding handle gear, among the pair of handle gears, in an axial direction,
wherein each angle adjustment gear is engaged with the corresponding handle gear,
the multifunction button further includes a front angle adjustment button and a rear angle adjustment button,
the front angle adjustment button is configured to rotate each angle adjustment gear of the corresponding handle angle adjustment device forward by a predetermined angle, and
the rear angle adjustment button is configured to rotate each angle adjustment gear of the corresponding handle angle adjustment device backward by a predetermined angle.

8. The variable steering wheel of claim 6, wherein:
the multifunction button further includes a mode switching button configured to switch a mode of the variable steering wheel between a normal driving mode and an autonomous driving mode, and
in the normal driving mode, the airbag and function button assembly is lowered to a lowest position thereof, and
in autonomous driving mode, the airbag and function button assembly rises to a highest position thereof, and the first handle body and the second handle body rotate radially inward until being aligned with the handle connection arm, while moving radially inward, so as to be positioned between the airbag and function button assembly and the handle connection arm.

9. The variable steering wheel of claim 8, wherein:
front and rear end portions of the first handle body are hollow tube structures, and the first handle body includes a first sliding groove extending along one surface thereof,
the first handle assembly further includes a first handle front extension and a first handle rear extension configured to slide within the hollow tube structures of the first handle body, respectively,
each of the first handle front extension and the first handle rear extension includes a first toggle button, and the first toggle button passes through the first sliding groove and is exposed from the one surface of the first handle body,
front and rear end portions of the second handle body are hollow tube structures, and the second handle body includes a second sliding groove extending along one surface thereof,
the second handle assembly further includes a second handle front extension and a second handle rear extension configured to slide within the hollow tube structures of the second handle body, respectively,
each of the second handle front extension and the second handle rear extension includes a second toggle button, and the second toggle button passes through the second sliding groove and is exposed from the one surface of the second handle body.

10. The variable steering wheel of claim 6, wherein:
the airbag and function button assembly further includes a convex shaft extending downward from a center portion of a lower surface thereof,
the convex shaft includes a convex shaft hole extending vertically from the lower surface of the airbag and function button assembly, and a sliding key extending in an axial direction of the convex shaft is provided on an inner surface of the convex shaft,
a sliding key groove is formed at an upper end portion of the main shaft along the axial direction,
a pair of position limiting structures is provided respectively at upper and lower ends of the sliding key groove, and the sliding key is slidable within the sliding key groove within a limiting range defined by the pair of position limiting structures.

11. The variable steering wheel of claim 6, wherein:
the steering device includes:
an upper cover including an upper cover shaft hole;
a steering gear fixedly mounted at a lower end portion of the main shaft;
an end shaft cover assembly fixedly mounted at the first end of the main shaft and including a magnetic body;
a printed circuit board (PCB) assembly including an angle sensor;
a steering force simulation device including a feedback gear; and
a lower cover coupled to the upper cover,
wherein:
the main shaft is configured to penetrate the upper cover shaft hole,
the angle sensor is disposed to face the magnetic body and configured to detect a rotation angle of the main shaft,
the feedback gear is configured to engage with the steering gear, receive a steering torque signal, and execute steering feedback, and
the PCB assembly and the steering force simulation device are mounted on the lower cover.

12. The variable steering wheel of claim 11, wherein:
the airbag and function button assembly further includes a steering angle display unit configured to indicate a steering angle of a vehicle.

13. The variable steering wheel of claim 6, wherein:
the airbag and function button assembly further includes a safety airbag and a mode indicator light, and
the mode indicator light is disposed to surround the safety airbag and is configured to emit light of different colors according to a change in a mode of the variable steering wheel, a change in a diameter of the steering wheel, or a change in an angle of the first handle assembly or the second handle assembly.

14. The variable steering wheel of claim 4, further comprising:
two rack gears provided in each track cavity, wherein the two rack gears are symmetrically positioned on opposite sides of a corresponding linear guide groove among the linear guide grooves, and
wherein two movement assembly gears are provided on each linear movement block, and each movement assembly gear is engaged with a corresponding rack gear among the two rack gears.

15. A method of assembling a variable steering wheel, the method comprising:
fixedly mounting rack gears on bottoms of a pair of track cavities at end portions of a handle connection arm, respectively;
mounting a pair of linear movement assemblies in a corresponding track cavity, among the pair of track cavities, at ends of the handle connection arm such that a movement assembly gear is engaged with a corresponding rack gear among the rack gears;
pivotably connecting a first handle shaft and a second handle shaft to a pair of linear movement blocks by passing through a pair of linear guide grooves at both ends of the handle connection arm, respectively;
fixedly mounting a handle gear to a lower end portion of each of the first handle shaft and the second handle shaft;
mounting a handle angle adjustment device so as to be engaged with the handle gear;
fixedly mounting a handle gear cover to a lower end of each of the first handle shaft and the second handle shaft;
allowing a main shaft to pass through a main shaft mounting hole of the handle connection arm and an upper cover and fixedly mounting a steering gear to a lower end of the main shaft;
fixedly mounting an end shaft cover assembly to the lower end of the main shaft;
mounting a printed circuit board (PCB) assembly and a steering force simulation device at a lower cover;
connecting the upper cover and the lower cover using a connection member; and
mounting an airbag and function button assembly at an upper end of the main shaft.

16. A method of adjusting a variable steering wheel, the method comprising:
using the variable steering wheel of claim 9;
entering an autonomous driving mode by pressing the mode switching button of the multifunction button in a normal driving mode; or
entering the normal driving mode by pressing the mode switching button of the multifunction button in the autonomous driving mode,
wherein, in the autonomous driving mode, the airbag and function button assembly rises to a highest position thereof, and the first handle body and the second handle body rotate radially inward until being aligned with the handle connection arm, while moving radially inward, so as to be positioned between the airbag and function button assembly and the handle connection arm, and
in the normal driving mode, the first handle body and the second handle body move to an outermost position in a radial direction and rotate to face each other, and the airbag and function button assembly is lowered to a lowest position thereof.

17. The method of claim 16, further comprising:
moving the first handle body and the second handle body radially outward by pressing the diameter increase button in the normal driving mode; and
moving the first handle body and the second handle body radially inward by pressing the diameter decrease button in the normal driving mode.

18. The method of claim 16, further comprising:
rotating the first handle body and the second handle body to face forward at a certain angle by pressing a front angle adjustment button in the normal driving mode; or
rotating the first handle body and the second handle body to face backward at a certain angle by pressing a rear angle adjustment button in the normal driving mode.

19. The method of claim 16, further comprising:
stretching or retracting the first handle front extension or the first handle rear extension relative to the first handle body by pushing the first toggle button forward or backward in the normal driving mode; or
stretching or retracting the second handle front extension and the second handle rear extension relative to the second handle body by pushing the second toggle button forward or backward in the normal driving mode.
